(19) United States
(12) Patent Application Publication
(10) Pub. No.: US 2024/0271338 A1
(43) Pub. Date: Aug. 15, 2024

(54) TWISTED COILED POLYMER ARTIFICIAL MUSCLES AND CONTINUOUS TEXTILE MANUFACTURING METHODS FOR THE SAME

(71) Applicant: UNIVERSITY OF UTAH RESEARCH FOUNDATION, Salt Lake City, UT (US)

(72) Inventors: Nicholas S. Witham, Dresden (DE); Florian Solzbacher, Salt Lake City, UT (US); Johannes Mersch, Dresden (DE)

(21) Appl. No.: 18/441,890

(22) Filed: Feb. 14, 2024

Related U.S. Application Data
(60) Provisional application No. 63/484,802, filed on Feb. 14, 2023.

(51) Int. Cl. D02G 3/44; D02G 3/04; D02G 3/12; D02G 3/36; D02G 3/38; D02J 1/22; D02J 13/00; D04C 1/12; F03G 7/06

(52) U.S. Cl. CPC D02G 3/447; D02G 3/04; D02G 3/12; D02G 3/36; D02G 3/38; D02G 3/441; D02J 1/22; D02J 13/00; D04C 1/12; F03G 7/0612; D10B 2331/02

(57) ABSTRACT

Highly twisted, coiled polymer actuators (TCPAs) are made by twisting polymer monofilaments in a first direction, plying the monofilaments in a second, opposite direction to form a yarn, then coiling the yarn. The resulting coil is annealed to form a functional TCPA. The disclosed manufacturing method is based on the false-twisting principle, and produce twisted filaments and twist-stable yarns continuously and rapidly. The twisted monofilaments can be associated with wires for heating and sensing. Because the yarns are twist-stable, they can be processed on standard textile machines to form contracting artificial muscles.

### CROSS-REFERENCE TO RELATED APPLICATIONS

This application claims priority to and the benefit of U.S. Provisional Application No. 63/484,802, filed Feb. 14, 2023 and titled “Twisted Coiled Polymer Artificial Muscles and Manufacturing Methods for the Same”, the entirety of which is incorporated herein by this reference.

### BACKGROUND

The present disclosure is directed to highly twisted, coiled polymer actuators (TCPAs) and methods of manufacturing the same.

In modern production environments, mechanical systems are utilized to perform fast, precise, and repeatable tasks in known settings. However, in unknown or changing environments, these machines lack the flexibility and adaptability of soft biological structures, which exhibit high resilience and flexibility, and use compliant materials to adapt to and match the rigidity of arbitrary objects. As a result, there has been increasing interest in soft robots, particularly in the field of soft actuators. Soft sensors and actuators enable compliant robotic systems to respond and interact with their surroundings.

While shape-memory alloys or polymers, pneumatic, hydraulic, and dielectric elastomer actuators are established actuator types in the field of soft robotics, they all have significant drawbacks. For example, they may require large peripheral equipment or be limited in maximum strain, force, or durability.

Twisted, coiled polymer actuators (TCPAs) are a promising type of fiber-based actuators with high energy density, low material costs, and good recyclability. Such actuator materials can exhibit good bending flexibility and robustness, as well as adaptable compliance. However, current manufacturing methods limit the length and stability of TCPAs, hampering their potential for large-scale applications, including mechatronic applications. Accordingly, there is an ongoing need for improved TCPAs and methods of manufacturing TCPAs.

### SUMMARY

Disclosed herein are TCPAs and methods of manufacturing TCPAs. Some embodiments enable effective manufacture of TCPAs using the false-twisting principle. Such methods beneficially allow for continuous and rapid production of highly twisted monofilaments, tubing, fiber bundles, or braids. Such starting materials are referred to collectively herein as “fibers” or “primary fibers”. Where many of the following examples refer specifically to monofilaments, it will be understood that the other types of primary fibers may be additionally or alternatively utilized.

The disclosed methods can also enable the plying of two or more twisted monofilaments to form twist-stable yarns, as well as the integration of wires for heating and sensing purposes. The resulting twisted monofilaments and twist-stable yarns can be mandrel-coiled and annealed. The disclosed methods can form a new class of TCPAs with three superimposed levels of helicity, in contrast to the two levels of conventional TCPAs. The twisted monofilaments and twist-stable yarns are also usable with large-scale textile manufacturing equipment such as for braiding, knitting, weaving, stranding, and the like.

In one embodiment, a method of manufacture includes: providing a suitable polymer fiber (e.g., through extrusion of suitable elastomers into monofilaments or tubing and linearizing the fibers through heated or room temperature drawing); optionally lubricating the fiber to enhance twisting and machine processing; twisting the fiber and/or plying the fiber with one or more additional fibers to form a yarn; optionally performing an intermediate heat setting step; forming the fiber/yarn into a coil; and heat setting the coil (e.g., at the length at which they are tensioned for coil formation). Forming the coil can be achieved by further twisting of the fiber/yarn under low tension until it coils with itself, coiling around a mandrel, or processing (e.g., plying or braiding) the fiber/yarn with one or more sacrificial fibers to form a multi-helical structure and removing the sacrificial fiber(s) following heat setting.

While many of the examples disclosed herein relate to twisted monofilaments that are plied into yarns and then coiled, it will be understood that alternative embodiments can omit the plying step and involve coiling of the twisted monofilaments. The plying step, however, can provide benefits such as providing twist-stable yarns and allowing for the formation of TCPAs with three levels of helicity.

Due to the twist-stability of the plied yarns, they can be processed on standard textile machines, enabling the manufacture of TCPAs with multiple active yarns that can form contracting artificial muscles using, for example, a circular braiding machine and/or other standard textile equipment. TCPAs disclosed herein can provide effective contractile performance, and have potential applications in large-scale textiles, robotics, and biomedical devices, for example.

In one embodiment, a twisted, coiled polymer actuator (TCPA) includes a first polymer monofilament including a twist in a first direction (e.g., Z) and a second polymer monofilament including a twist in the first direction. The first and second polymer monofilaments are plied together in a second direction (e.g., S), which is opposite the first direction, to form a yarn. The yarn can further be coiled. For example, the yarn may be coiled singularly or with one or more additional yarns, such as within a braid.

The TCPA beneficially comprises three levels of overlapping helicity, provided by: the twist in the polymer monofilaments (first level of helicity), the ply of two or more polymer monofilaments (second level of helicity) forming a yarn, and the coil (third level of helicity) formed from the yarn.

In one embodiment, a method of manufacturing the TCPA comprises: twisting a first polymer monofilament in a first direction; twisting a second polymer monofilament in a first direction; plying the first and second polymer monofilaments in a second direction, opposite the first direction, to form a yam; coiling the yarn to form a coil; and annealing the coil.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIGS. 1A and 1B show chirality Z and S of a coiled monofilament on a mandrel, and certain geometry parameters including mandrel diameter D, fiber diameter d, pitch p and bias angle α.

FIG. 2 illustrates multiple levels of helicity of an example TCPA, showing a twisted polymer monofilament (first level of helicity), two plied polymer monofilaments (second level of helicity) that form a yarn, and the yarn formed into a coil (third level of helicity).

FIGS. 3A and 3B are flowcharts for example methods of manufacturing TCPAs.

FIG. 3C is a schematic of an example twist-plying machine that utilizes the false-twist principle to twist and ply monofilaments, optionally with a conductive wire.

FIG. 4 is a graph showing the influence of the annealing temperature on the temperature-strain cycle of monofilament TCPAs with 650 twists per meter (tw per m).

FIG. 5 is a graph showing the influence of cool-down speed on the temperature-strain cycle of monofilament TCPAs with 650 tw per m.

FIG. 6 is a graph showing the influence of twist density of monofilament TCPAs on their temperature-dependent contractility.

FIG. 7 is a graph showing the temperature-induced contraction and expansion of twist-plied TCPAs based on differing chirality profiles.

FIG. 8 is a graph showing the influence of the twist-writhe ratio of the yarn used to form the TCPAs on their temperature-dependent contractility.

FIG. 9 shows an example configuration of yarns in a braiding machine for forming a TCPA braid.

FIG. 10 is a graph showing the temperature dependent contractility of the TCPA braid with a braiding density of 5 braids/cm.

FIGS. 11A-11C illustrate results of coil geometry testing, where FIGS. 11A and 11B show tensile stress and torque over strain values, and FIG. 11C shows the change in tensile energy over strain values as calculated using tensile force and displacement data.

### DETAILED DESCRIPTION

### Overview of TCPAs

TCPAs can contract more than 40% upon activation by heating. Relative to other types of actuators, TCPAs can exhibit high contractility, high energy density, low cost, and low hysteresis. TCPAs work based on the anisotropic thermal expansion of certain polymer types, such as polyamide or polyethylene. When these polymers are spun and drawn into fibers, their semi-crystalline structure results in an axial contraction and radial expansion of the fiber, or vice versa. A typical polyamide fiber can contract up to 4% when heated from 20 to 250° C., for example.

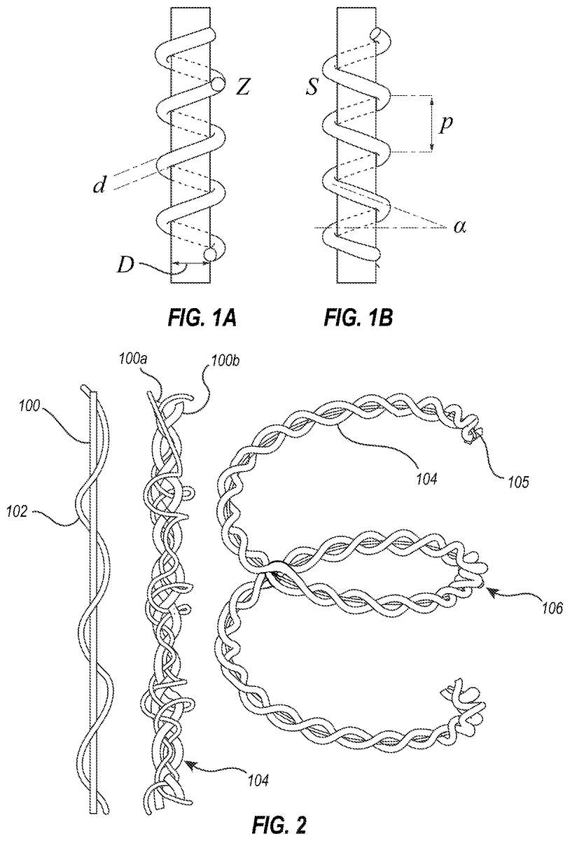

Polymer materials that possess such contraction properties can be processed into TCPAs. In certain methods, a fiber can be twisted under tension until it coils spontaneously into a self-contacting helix, or manually coiled into a chosen helical shape at a lower level of twist onto a mandrel. The major difference between non-mandrel-coiled and mandrel-coiled TCPAs is that non-mandrel-coiled TCPAs exhibit inter-coil-contact (ICC), meaning that the fiber is in contact with itself between two windings of a helix, such that the pitch p is equal to the fiber diameter d (see FIGS. 1A and 1B for illustrations of certain helix elements). Consequently, non-mandrel-coiled TCPAs require a pre-loading force to contract efficiently. Twist induced TCPAs can be stretched and re-annealed to minimize or avoid ICC. “Pre-training” the TCPAs through repeated stretching can also provide a rest length with sufficient room to contract without ICC. Mandrel-coiled TCPAs can be produced within a wide range of helix geometries and without initial ICC; however, their energy density is lower than that of non-mandrel-coiled TCPAs due to their lower level of twist, which is related to potential energy.

The resulting coil can be homochiral or heterochiral, depending on the handedness of the twist in the fiber and coil. The coil is then annealed to relax embedded stresses and permanently set its shape. When subsequently reheated, the annealed monofilament will try to untwist, resulting in a torque that causes the coil to expand or contract based on factors such as the relative level of twist and writhe in the yarn used to form the coil.

A higher-twisted fiber provides a coil with higher potential energy. The coil's geometry can be defined by two metrics: spring index

$$SI = ( \frac{D + d}{d} )$$

and bias angle α, where D is the mandrel diameter and d the fiber diameter. Small spring index, high-bias-angle coils are stiffer and provide more mechanical energy due to their larger changes in torque, meaning they can do more work, but often contract less when unloaded.

The coil can be heated by running a current through a conductive element such as a conductive coating or an added metal wire, for example. The conductive element may include a conductive coating (e.g., made of silver particles), carbon nano tubes, or metallic (e.g., copper) wires. A conductive element such as a wire can also be used to measure the TCPA's temperature and elongation to allow closed-loop control. Certain applications such as orthotics or soft robotics can utilize such electrically conductive elements, for example. A conductive wire can be integrated with the TCPA during the twisting and coiling process, which can serve two purposes. First, a power source can inject a current for Joule heating into the wire. Second, the wire can be used as a resistive or inductive sensor for self-sensing and subsequent control capabilities.

FIGS. 1A and 1B show chirality Z and S of a coiled fiber on a mandrel, and certain geometry parameters including mandrel diameter D, fiber diameter d, pitch p and bias angle α.

### Conventional Manufacturing Methods

Conventional manufacturing methods involve taking a defined length of fiber, usually around 1000 mm, applying stress to it, fixing one end rotationally on a hook, and twisting the other end using a stepper motor. This process drastically reduces the length of the resulting twisted and coiled fiber to around 20-30% of its original length. Consequently, the manufacture of textiles from these TCPAs has been done manually because the limited lengths available are not suitable for standard textile machines. Even automated manufacturing processes that include twisting and winding produce short actuators less than 10 cm in length. Additionally, the twisted fibers are highly unstable and can lead to unwanted plectonomes or snarls if the tension is relaxed below a certain threshold before annealing or coiling. The twisted fibers can also bind inadvertently with other fibers or components of the textile machine during production, making the conventional manufacturing processes unsuitable for large-scale production.

Another previous manufacturing method involves twisting multiple filaments that have been bundled together in parallel. However, these multi-filament yarns are not twist-stable and have the same problems as twisted monofilaments with regard to their restricted length.

Another approach that attempts to circumvent this twist-stability issue is externally fixing the inserted rotation. This requires the introduction of a second material system after twist insertion. Several options have been explored, for example using a soft elastomer to infiltrate the TCPA or a second, interpenetrating polymer network. In general, these strategies imply a second passive material that counteracts the TCPA's active deformation, which is disadvantageous for most applications.

Alternatively, it is possible to make active multi-ply yarns using three or more separate hooks. By tying several monofilaments to a rotationally fixed swivel hook at one end and to multiple rotating hooks at the other end plied yarn can be made. While each fiber is twisted the same amount, the fibers are kept separate. After twisting, the rotationally fixed hook is released, allowing the fibers to spontaneously ply together until they reach a torsional equilibrium. The downside of this method is that it does not offer any way to control the plying step. In addition, the final actuator is severely restricted in length because the twisted and already shortened filaments wrap around each other during plying.

In contrast to these conventional approaches, the presently disclosed methods enable scalable manufacturing processes and are beneficial in a variety of applications, including the manufacture of active filters, thermal-adjustable clothing or shading textiles, prostheses, power generation under diurnal temperature fluctuations or through association with heat sources (e.g., waste heat capture), or active soft structures made of fiber-rubber composites. While prosthetics and orthotics have been the main focus of TCPAs in recent years, there has been increasing interest in the field of energy harvesting in general, and specifically in low-grade waste heat. Such applications would benefit from large woven belts or other such scaled structures. The presently disclosed textile-processable, continuous highly twisted fibers are therefore beneficial for such applications.

### Improved TCPA Structural Features

TCPAs disclosed herein can comprise: a first polymer monofilament including a twist in a first direction; and a second polymer monofilament including a twist in the first direction. The first and second polymer monofilaments can be plied together in a second direction, opposite the first direction, to form a yarn. Monofilaments or yarns can be coiled into a coil shape, such as a single helix or double helix formation. Coiling can be accomplished by further twisting of the monofilament or yarn until spontaneous coiling occurs, though coiling using a mandrel or further plying with a sacrificial fiber (removed after heat setting). In some embodiments, the yarn is coiled with one or more additional yarns, or with one or more sacrificial fibers, to form a braided structure (e.g., a tubular braid).

Although the examples described herein most often refer to polymer monofilaments, it will be understood that polymer tubing may additionally or alternatively be utilized in the disclosed embodiments. Any suitable polymer or combination thereof may be utilized to form the polymer monofilaments, including, for example, polyamide, polyethylene, polypropylene, polyacrylonitrile, polyethylene terephthalate, polyvinyl chloride, and polycarbonate.

Also, while the described examples most often relate to temperature-responsive actuators, the same principles and methods may be applied to other types of helical actuator materials, such as those that respond to electrical, chemical, or light-based actuation stimuli.

The disclosed TCPAs beneficially comprises three levels of overlapping helicity, provided by: the twist in the polymer monofilaments (first level of helicity), the ply of two or more polymer monofilaments (second level of helicity) forming a yarn, and the larger coil (third level of helicity) formed from the yarn.

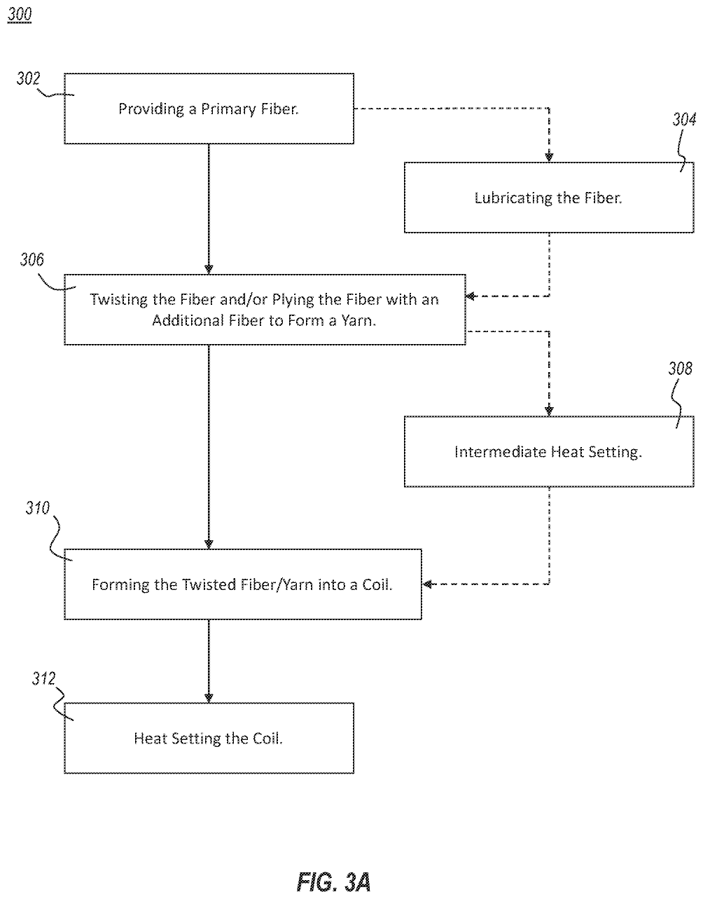

FIG. 2 illustrates multiple levels of helicity of an example TCPA, showing a twisted polymer monofilament 100 (first level of helicity), two plied polymer monofilaments 100a and 100b (second level of helicity) that form a yarn 104, and the yarn 104 formed into a coil 106 (third level of helicity). In FIG. 2, the light lines 102 represent the twist within the polymer chain of the respective monofilaments 100 when twisted. The light line 105 represents the center line of the yarn 104.

As used herein, unless specified otherwise or made clear from context, the term “twist” refers to the twist applied to the primary fibers (i.e., monofilaments, fiber bundles), whereas the term “writhe” refers to the specific twist applied in plying one or more primary fibers together.

The yarn 104 can be coiled, and the coil can extend in the first direction (i.e., the same direction as the twist of the monofilaments 100 and opposite the writhe direction) or can extend in the second direction (i.e., opposite the direction of the twist of the monofilaments but the same as the writhe direction). Because the disclosed TCPAs can include three levels of helicity, the conventional use of the terms homochiral and heterochiral do not perfectly apply. Nevertheless, as used herein, the term “homochiral” refers to a TCPA in which the writhe direction and the coil direction are the same, whereas the term “heterochiral” refers to a TCPA in which the writhe direction and the coil direction are opposite. Torque direction is the same as the coil direction.

The TCPAs can also include a conductive element in contact with the polymer monofilaments. The conductive element can include, for example, a conductive wire (see conductive wire 210 in FIG. 2), a conductive coating, and/or carbon structures (e.g., carbon nanotubes). In some embodiments, the conductive wire 210 can be plied with the monofilaments 100 used to form the yarn 104. The conductive wire 210 can extend within the yarn 104 such that it is substantially centered relative to the plied monofilaments 100, or alternatively can extend along an outer portion of the yarn 104, such as by being wrapped around the yarn 104. Embodiments that include a conductive coating can include a coating of metal particles, for example, such as silver particles and/or other suitably conductive particles.

Yarns 104 manufactured according to the disclosed methods are beneficially twist-stable. Twist-stability refers to the ability of the yarn 104 to maintain its original twist level over time. The twist-stable yarns 104 resist untwisting and remain structurally intact during handling, braiding, knitting, weaving, or other textile processes. Due to their twist-stability, the plied yarns 104 are readily processed on textile machines without requiring previous annealing. This beneficially enables effective manufacture of mandrel-coiled TCPAs and active braid TCPAs, for example.

TCPAs manufactured according to the disclosed methods can advantageously have lengths that are greater than TCPAs manufactured using conventional methods. Conventional methods typically start with a defined length of fiber, usually about 100 cm, and twist and coil the fiber with the resulting structure having a drastically reduced length. Even automated conventional methods that include twisting and winding result in short actuators that are less than 10 cm in length. In contrast, the disclosed methods enable the manufacture of TCPAs with essentially any desired length. That is, TCPA length can be determined by particular application needs and cost targets rather than inherent manufacturing limitations. In some embodiments, a TCPA has a length of 10 cm or greater such as 15 cm or greater, 20 cm or greater, 30 cm or greater, 40 cm or greater, 50 cm or greater, 60 cm or greater, 70 cm or greater, 80 cm or greater, 90 cm or greater, 100 cm or greater, or even longer lengths if desired.

The monofilaments 100 can be twisted and writhed/plied to any suitable level. Generally, higher twist densities are desired, though excess twisting for a given material can increase the risk of breakage and/or downstream manufacturing issues. Example TCPAs found to be effective include a twist level of 400 twists per meter (tw per m) to 1,000 tw per m or, for certain applications, up to higher twist densities such as 25,000 tw per m. Examples include about 450 tw per m, 500 tw per m, 550 tw per m, 600 tw per m, 650 tw per m, 700 tw per m, 750 tw per m, 800 tw per m, 850 tw per m, 900 tw per m, 950 tw per m, 1,000 tw per m, 1,500 tw per m, 2,000 tw per m, 2,500 tw per m, 3,000 tw per m, 3,500 tw per m, 4,000 tw per m, 4,500 tw per m, 5,000 tw per m, 7,500 tw per m, 10,000 tw per m, 15,000 tw per m, 20,000 tw per m, 25,000 tw per m, or within a range that uses any combination of the foregoing values as endpoints. The yarns 104 can include writhe levels (i.e., the number of twists per meter used to ply the monofilaments 100 together) within any of the foregoing values. While such twist and writhe levels were found to be effective, some embodiments may utilize other twist and/or writhe levels according to application needs or preferences and may, for example, use greater twist densities and/or writhe densities.

The present disclosure enables the control and customization of the twist level to writhe level (“twist to writhe ratio”). The twist to writhe ratio refers to the twist level of the monofilaments 100 (as numerator) relative to the writhe level used to ply the monofilaments 100 together to form the yarn 104 (as denominator). The ability to control and customize this ratio is an advantage relative to conventional methods that do not allow for such adjustment.

In some embodiments, the yarn 104 has an uneven twist to writhe ratio (i.e., a twist to writhe ratio that does not equal one). Testing has demonstrated that an uneven twist to writhe ratio can enhance performance, such as by providing greater contractility relative to TCPAs with more balanced twist to writhe ratios. The TCPAs can have a twist to writhe ratio, for example, of 0.4 to 0.9, or 0.5 to 0.8, or 0.6 to 0.7, or be within a range that includes any combination of the foregoing as endpoints.

The coil 106 can be configured according to desired properties. In some examples, the yarn 104 is coiled such that the resulting coil 106 has a spring index of about 1 or less than 1 and a bias angle of 5° to 20°. Other coil configurations may also be utilized according to application needs and/or preferences.

### Example Methods of Manufacture

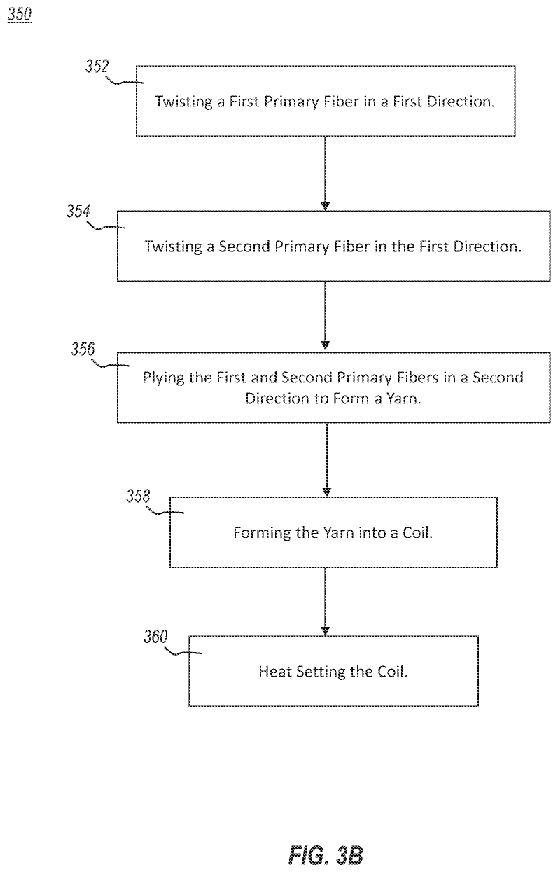

In one embodiment, as illustrated in FIG. 3A, a method of manufacture 300 includes: providing a suitable polymer fiber (step 302) (e.g., through extrusion of suitable elastomers into monofilaments or tubing and linearizing the fibers through heated or room temperature drawing); optionally lubricating the fiber (step 304) to enhance twisting and machine processing; twisting the fiber and/or plying the fiber with one or more additional fibers to form a yarn (step 306); optionally performing an intermediate heat setting step (step 308); forming the twisted fiber/yam into a coil (310); and heat setting the coil (step 312) (e.g., at the length at which they are tensioned for coil formation). Forming the coil can be achieved by further twisting of the fiber/yarn under low tension until it coils with itself, coiling around a mandrel, or processing (e.g., plying or braiding) the fiber/yam with one or more sacrificial fibers to form a multi-helical structure and removing the sacrificial fiber(s) following heat setting.

The methods disclosed herein can also include pre-coiling of monofilaments or yarns. Such a step can beneficially provide smaller spring indexes that are difficult to obtain with mandrel forming alone. Pre-coiling can be carried out by mandrel coiling or inducing coiling by twisting the fiber as a separate process before it is coiled into its final coil shape. The slight helical shape of the pre-coiling step assists in forming a tighter final coil shape. Pre-coiling can also decrease the likelihood of fiber breakage during manufacturing. Pre-coiling can be done at room temperature or at an increased temperature. The pre-coiled shape can be temporary (without intermediate annealing) or permanent (with intermediate annealing prior to subsequent manufacturing steps).

Additionally, or alternatively, the methods disclosed herein can include a step of further twisting an already-formed coil. As with the pre-coiling step, this step can beneficially provide smaller spring indexes that are difficult to obtain with mandrel forming alone. The fiber will have an inherent helical shape when not tensioned, and the further twisting steps can be carried out under tension using any suitable twisting equipment such as disclosed elsewhere herein.

As illustrated in FIG. 3B, another example method 350 of manufacturing a TCPA includes: twisting a first primary fiber in a first direction (step 352); twisting a second primary fiber in the first direction (step 354); plying the first and second primary fibers in a second direction, opposite the first direction, to form a yarn (step 356); forming the yarn into a coil (step 358); and annealing/heat setting the coil (step 360). The method 350 can also incorporate any of the features described in relation to method 300 of FIG. 3A. By using a plying machine based on the false-twist principle to ply twisted fibers into twist-stable yarns, the method can be carried out to manufacture twist-plied yarns continuously, optionally without previous annealing, allowing for their use in established largescale manufacturing methods such as braiding, knitting, weaving, and stranding. The method also beneficially allows control of both the twisting and plying parameters independently, unlike many conventional approaches.

The monofilaments can be provided by extruding thermally responsive elastomers (e.g., including any of the polymers disclosed herein for such purposes), and linearizing the filament fibers through heated or room temperature drawing. The fibers can optionally be lubricated to enhance subsequent twisting and machine processing. The yarn can optionally be annealed/heat set prior to being formed into a coil, though in some embodiments, such intermediate heat setting can be omitted. The method can further include additional twisting and annealing of the TCPA as desired, integration of a conductive element (e.g., wire and/or coating), and/or further textile processing such as braiding, stranding, knitting, weaving, etcetera.

The step of coiling the yarn can be carried out in a variety of ways, including, for example, (i) further twisting under low tension until spontaneously coiling occurs, (ii) coiling the yarn around a mandrel, or (iii) further plying and/or braiding (e.g., into a tubular braid) with a sacrificial fiber that is removed after heat setting.

Annealing and cooling steps can be varied according to materials used and application needs. In some examples, annealing is carried out at a temperature of 2100° C. or less, for a duration sufficient to remove twist liveliness.

FIG. 3C represents an example twist-plying machine 200 that utilizes the false-twist principle to twist and ply monofilaments 100, optionally with a conductive wire 210. As illustrated, the machine 200 can include a monofilament let-off spool 202, a conductive wire let-off spool 204, tensioning elements 206 (e.g., spring-loaded thread brakes and/or other suitable tensioning mechanisms), and a yarn guide 212 configured to be rotatable around the take-up spool 216. The conductive wire 210 is guided by one or more guide mechanisms 208 to bypass the twist insertion function of the yarn guide 212. In use, the yarn guide 212 rotates to apply twist to monofilaments 100. The conductive wire 210 can be integrated during the plying step in which monofilaments 100 are plied in the opposite direction of the initial twist insertion. The resulting plies are twist-stable due to the interlocking of the individual monofilaments. Once the monofilaments 100 are combined with the conductive wire 210, they are fed to the traversing unit 214 and wound onto the take-up spool 216. To assist in providing tension to the highly twisted monofilaments, the take-up spool 216 can be driven directly rather than via friction.

### Working Examples

Thermo-mechanical analysis was performed on both the twisted monofilaments and plied yarns to investigate their contractility. The effects of twist density, writhe level, handedness, annealing temperature, and cooling speed after annealing were examined for the monofilaments and yarns. Furthermore, the twist-stable plies were processed on a braiding machine to produce thermo-active braids, thus demonstrating the capability of manufacturing the twist-plied polymer actuators using standard textile equipment.

### 1) Twist-Plying

To manufacture twist-plied TCPAs the following steps are carried out and further described below (exemplary for a contracting TCPA):
1. Twisting of monofilament 1 in the Z-direction (first helix level)
2. Twisting of monofilament 2 in the Z-direction (first helix level)
3. Plying of monofilament 1 and 2 and the heating wire in the S-direction (second helix level)
4. Winding of twist-plied yarn around steel mandrel in the S-direction (third helix level)
5. Annealing of coil on the mandrel
6. Removing the mandrel
7. Thermo-mechanical testing.

The monofilament used in the experiments was a polyamide 6 fiber with a nominal diameter of 0.3 mm (Perlon Monofil, Perlon Nextrusion Monofilament GmbH, Bobingen, Germany). As the additional heating element, a copper wire with a diameter of 0.12 mm was inserted during the twisting process (Elektrisola Gerd Schildbach GmbH, Reichshof, Germany).

The DirectTwist 6D ply twister (AGTEKS), based on the false-twist principle, was employed to twist the monofilaments to various twist densities ranging between 400 and 1000 twists per meter (tw per m). The reference length of the twisted fiber was measured using a rotary wheel to regulate the length of the wound-up fiber. It is worth noting that the machine can only achieve a maximum twist density of 650 tw per m. Hence, the monofilament with a twist density of 1000 tw per m was produced in two twisting steps, with the first step producing 650 tw per m and the second step producing 350 tw per m. The monofilament and copper wire were fed to the twister from below, with the copper wire guided around and over the twist insertion mechanism (see FIG. 2).

To apply tension to the fiber, spring-loaded thread brakes were installed over the let-off spools; however, due to the false-twist effect, the fiber between the let-off spool and the twist application location was twisted in the opposite direction of the fiber on the take-up spool. To prevent tangling of the fiber between the tensioning and let-off spools, the let-off spool was also tensioned. The tension was applied by a screw that pressed a fleece ring to the let-off spool. As a result, the fiber was pulled off the spool tangentially instead of overhead. The yarn guide was rotated around the take-up spool to apply the twist to the monofilament. Once the twisted monofilaments were combined with the wire, they were fed to the traversing unit and wound onto the take-up spool. The take-up spool was driven directly instead of via friction to apply tension to the twisted monofilaments.

During plying, two twisted monofilaments were twisted in opposite handiness of the initial twist insertion, that is, heterochirally. During the plying step, the copper wire was integrated. The resulting plies are twist-stable due to the interlocking of the individual monofilaments. Twist-stability was defined as no hockling or snarling after tension is completely released.

### 2) Mandrel Coiling/Braiding

For transforming the highly twisted monofilaments into linear actuating TCPAs, they were wound onto steel mandrels using a laboratory winding machine (IWT Industrielle Wickeltechnik GmbH, Erlangen, Germany). The twisted monofilaments or plies were wound around mandrels with a diameter of 4 mm at a pitch of 3 mm, resulting in a spring index of 14.3 and a bias angle of 12°. These parameters were chosen because the effect of coil diameter and bias angle has been extensively studied in previous works. Additionally, the winding direction was kept constant over all samples to produce S-handed coils.

Another method of creating TCPAs is by braiding the plies. In a circular braiding machine, half of the yarns run clockwise and the other half counterclockwise, resulting in several intertwined helices with opposite handedness. In this study, a half-loaded circular braiding machine (Herzog GmbH, Oldenburg, Germany) was used to process six twisted and plied yarns. The braiding poles rotated around the 4 mm mandrels to form braids with a defined diameter, and the yarns ran around the mandrel, directly forming the TCPA braid on the mandrel. After annealing the produced braids on their mandrels, the mandrels were removed, and the braids were cut into 100 mm samples. These samples were fixed with crimps on both sides and tested using the same methodology as the single coils.

After the coiling or braiding process, the monofilament ends were fixed to the mandrel using Scotch tape and annealed suspended over a hot plate (Harry Gestigkeit GmbH, Dusseldorf, Germany) for 1 hour. The annealing temperature varied between 150 and 240° C.

### 3) Thermo-Mechanical Characterization

The TCPAs were characterized in a climate chamber (Angelantoni Test Technologies DY110, Massa Martana, Italy) to obtain their temperature-strain curves. To ensure reliable results, three samples were manufactured and tested for each parameter set, and the strain curves were individually calculated and averaged. The SEM was used to represent the error bars in the diagrams. A camera (VCXU-23M, Baumer Group, Frauenfeld, Switzerland) equipped with a 75-mm focal length objective was set up in front of the climate chamber for recording the temperature-strain curves. To prevent temperature-unrelated movement of the samples caused by the fan that drives warm and cold air into the chamber, the samples were placed in a three-dimensional printed box; however, this resulted in a temperature difference between the sample temperature and the temperature measured by the internal temperature probe of the climate chamber. Hence, an additional thermocouple was placed inside the sample box, and its temperature signal was used for the temperature-strain curve. It should be noted that the temperature inside the box is delayed and differs from the temperature recorded by the climate chamber.

During characterization, each sample underwent thermal cycling between 25° C. and 100° C. (internal sensor) at the maximum heating rate of 3.6 K/min. The monofilaments were preloaded with small weights of 1 g, resulting in a pre-stress of 0.14 MPa with respect to the monofilament cross-sectional area. The strain was calculated in relation to the tensioned coil length.

To minimize unwanted reflections in the climate chamber's glass door, a light source was placed inside, and the rest of the room was kept dark during the measurements. Before each heating cycle, a pixel-to-length calibration was carried out to determine the samples' deformations. To correct lens distortion, MATLAB's camera calibration toolbox was employed. The images were then analyzed using a simple computer vision algorithm in MATLAB, which used an adaptive threshold to binarize the image and extract the position of the weights. The resulting resolution was 0.1 mm per pixel. Both the thermocouple and camera were set to measure at a 1-Hz rate.

### 4) Monofilament Testing

Initially, an annealing protocol was developed to determine the optimal parameters for the subsequent experiments. For this purpose, TCPAs comprising monofilaments with a twist density of 650 tw per m were produced and annealed for 1 h at temperatures ranging from 150 to 240° C. After annealing, the TCPAs were allowed to cool on the steel mandrel following the deactivation of the heat plate; however, at the highest temperature of 240° C., the monofilament became molten and adhered to the mandrel, rendering the samples unusable. Therefore, TCPAs annealed at temperatures ranging from 150 to 210° C. were selected for further testing.

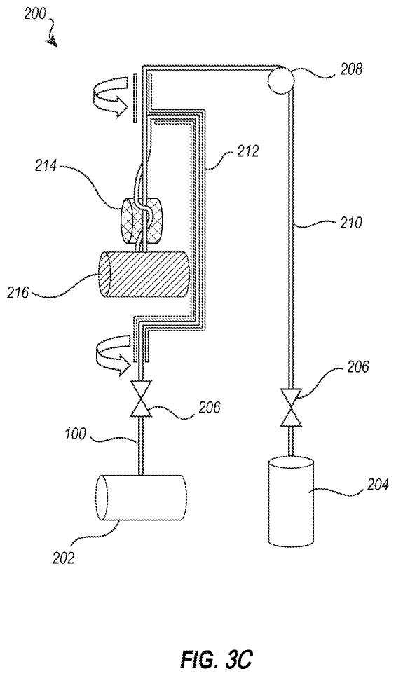

The results presented in FIG. 4 indicate that the samples annealed at lower temperatures experienced a greater degree of contraction; however, it is noteworthy that the samples annealed below 210° C. did not fully recover their initial length upon cooling. Therefore, for the subsequent experiments, the annealing temperature was held constant at 210° C. This behavior can be explained by the insufficient molecular mobility at low temperatures, which prevents the twisted coiled polymer chains from fully relaxing. Subsequently they relax further during the activation resulting in unrecovered strain after cooldown to room temperature.

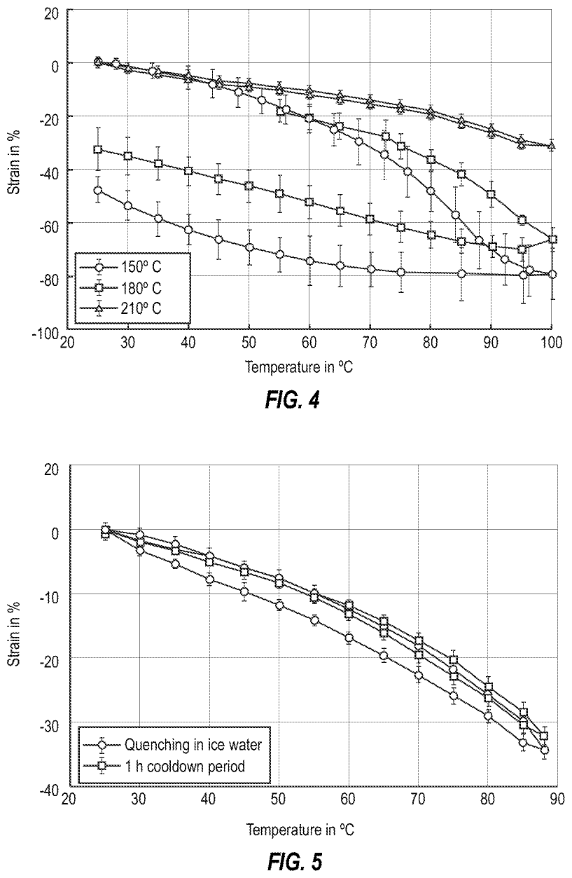

The cooling speed was also investigated to determine its effect on the TCPA's performance. While a faster cooling speed can increase production throughput, it can also have detrimental effects on the material's properties. FIG. 5 illustrates that quenching the TCPA in ice water results in a significant increase in hysteresis. This behavior is likely due to the presence of voids in the amorphous regions of the polymer. The voids are a result of the faster cooling speed that does not allow the polymer chains to fill the voids before their mobility is restricted; a well-studied phenomenon leading to lower densities and a smaller share of crystalline regions. Therefore, a cooldown period of 1 h was chosen for subsequent experiments. Although a faster cooldown may be acceptable for certain applications that do not require high precision, it negates one of the main advantages of TCPAs over shape-memory alloys.

To evaluate the influence of the twist level of the monofilaments on coil contractility, monofilaments with different twist densities were manufactured and tested. The initial diameter of the monofilament was 0.31 mm, and the monofilaments' diameter decreased with increasing temperature. Although we initially anticipated that the diameter would increase with higher twist levels, no clear trend was observed. Previous publications have reported a shortening and thickening of fibers upon twisting, but it is worth noting that the fiber diameter does not significantly affect the maximum actuator performance. Therefore, regardless of whether this discrepancy is attributed to material or process-related factors, it is unlikely to significantly impact the overall results.

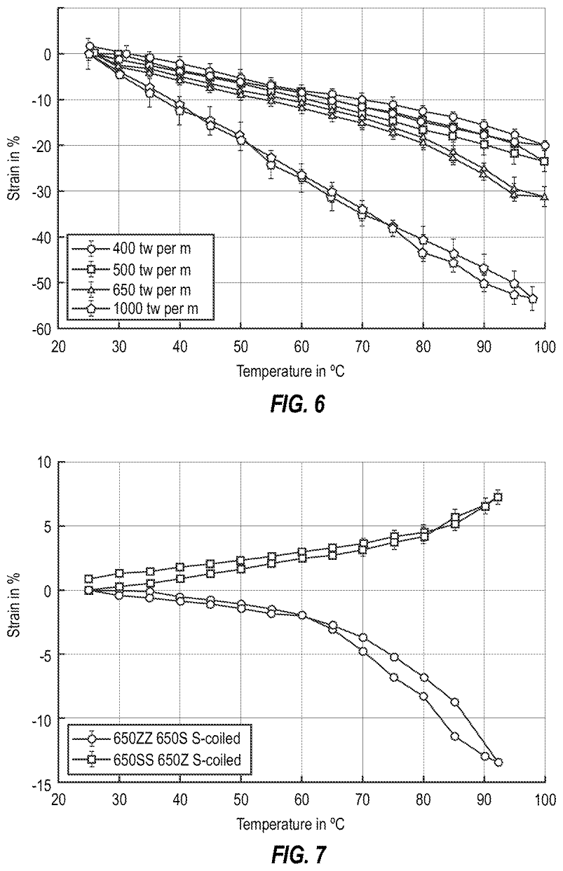

The temperature-dependent contraction of the samples is presented in FIG. 6. The results demonstrate that a higher twist density of the monofilaments leads to greater contraction. Therefore, a higher twist density could result in improved performance; however, it should be noted that the additional twisting process required to increase the twist density from 650 tw per m to 1000 tw per m is prone to error due to filament hockling/snarling when tension is too low. Hence, we selected a maximum twist density of 650 tw per m for subsequent experiments. Moreover, the temperature-strain relationship for all types of monofilament show a high linearity and the actuators recover their initial length after a full activation cycle. The amount of hysteresis during activation is also low.

### 5) Twist-Plied TCPA Testing

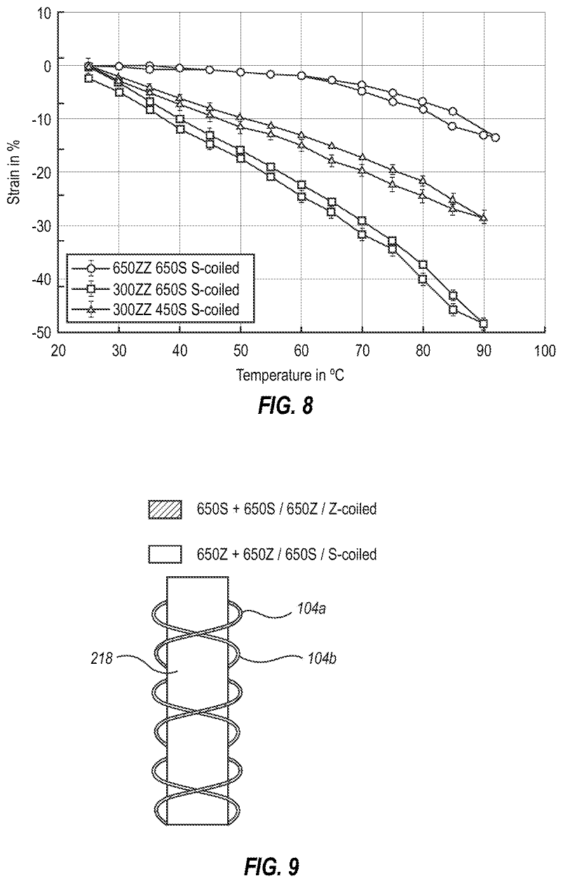

FIG. 7 depicts a comparison of the temperature-contraction relationship of TCPAs with opposite directions of twist and writhe, both of which are coiled in the S-direction. The twist and writhe densities were 650 tw per m, and the resulting yarns had a diameter of 0.51 mm at room temperature. Consequently, the spring index is lower than that of the monofilament coil, but all coils have the same bias angle of 12°.

A ‘homochiral’ contracting twist-plied coil is made up of a Z-twisted, S-plied, and S-coiled TCPA, whereas a ‘heterochiral’ expanding coil includes an S-twisted, Z-plied, and S-coiled TCPA. This demonstrates the feasibility of using twist-plied and stable yarns in TCPAs. Furthermore, the ability to produce twist-stable and actuating plies with opposite handedness enables the use of braiding technology to manufacture either contractile, expansive, or constant-length TCPA bundles continuously.

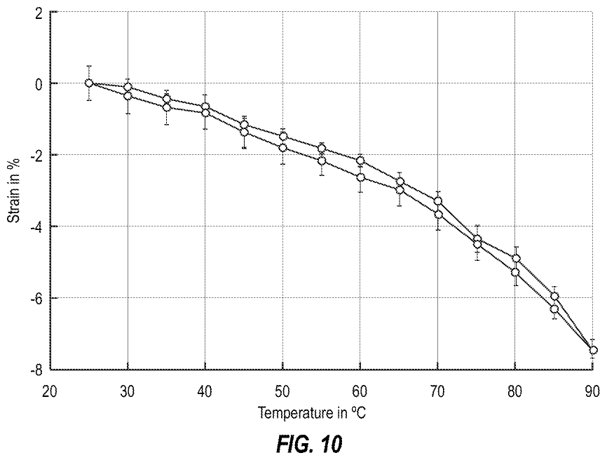

The chirality of twist-plied TCPAs adds an additional degree of freedom, namely, the ratio between twist and writhe. To investigate its influence, the writhe was kept constant while the twist level was varied to 300 and 450 tw per m, with results shown in FIG. 8. For conventional twist-coiled polymer actuators, higher twist levels typically result in greater deformation; however, for twist-plied TCPAs, lower twist levels can lead to larger contractions. This suggests that an uneven twist-writhe ratio could potentially enhance performance, provided that the plied yarns remain twist-stable. All three tested plied yarns were twist-stable. A potential cause leading to the better performance of TCPAs with uneven twist-writhe ratios is that they are closer to an unbalanced and unstable filament and/or that larger uptorque is involved. At a certain point, however, the ply probably becomes unstable if twist and writhe differ excessively. Consequently, the twist to writhe ratios disclosed herein can effectively balance the benefits of an uneven ratio without risking instability.

The twist-plied yarns were also processed on a standard braiding machine. Plies that were stable in twist and had an additional copper wire were produced with opposite handedness. The copper wire did not undergo twisting during insertion, but it wrapped around the twist-plied yarn. The copper wire could alternatively be located at the center of the yarn for increased heating efficiency.

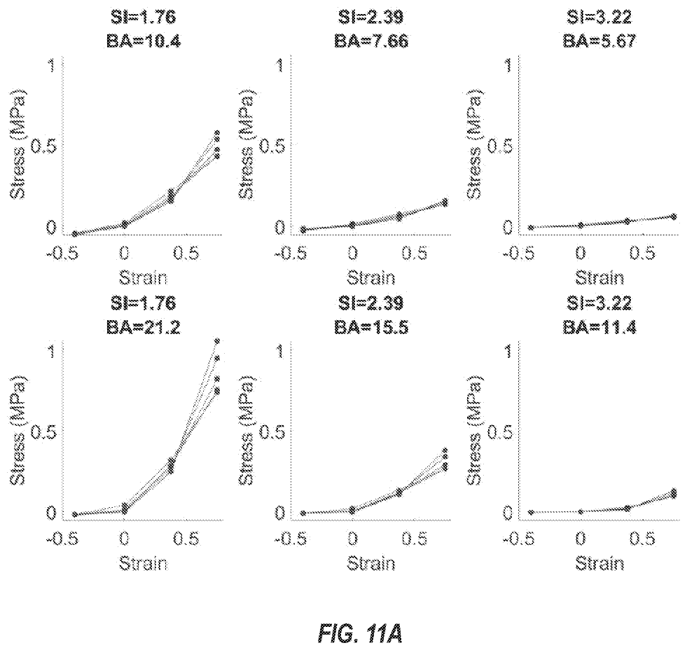

As shown in FIG. 9, the yarns with writhe in the S-direction ran counterclockwise in the braiding machine, resulting in an S-coil on the mandrel. Conversely, the yarns with Z-writhe ran clockwise, resulting in a braid composed of six contractile coiled-yam TCPAs. With a braiding density of five braids per cm, the pitch of the individual coils was 12 mm. The same mandrel with a diameter of 4 mm was used, resulting in a bias angle of 40°, which was higher than that of the single coils' geometry.

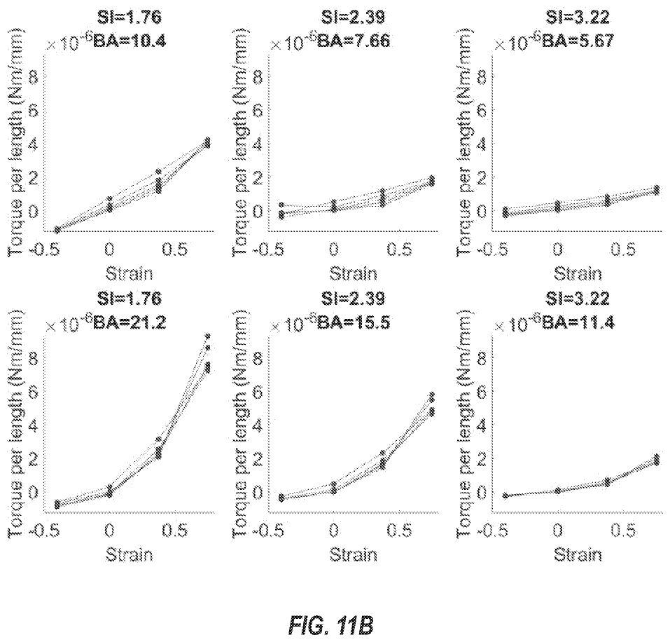

The temperature-strain test results of the TCPA braids are presented in FIG. 10. The maximum contraction observed was 7.4%, which is half the contraction of a single coil made from the same yarn. This is due to the inter-coil contact (ICC) of the yarns in the braid, which restricts further contraction. A higher pre-loading force could lead to larger contractions and consequently higher energy densities. As an alternative, the braid density can be lowered to achieve further deformation before ICC. This is one of the major advantages of such braided or mandrel-coiled TCPAs. By adjusting pitch and spring index, the strain-stress relation can be tailored to a specific application. In addition, the TCPA braid recovers its initial length after activation and shows only minor hysteretic behavior. This suggests that the ICC and potentially resulting friction between multiple yarns in the braid does not inhibit the actuation performance.

### 6) Coil Geometry Testing

A series of tests were carried out to evaluate the relationship between TCPA coil geometry, torsion, and tension. Yarns were created from two linear low-density polyethylene (LLDPE) monofilaments, each twisted in the S direction (twist density=350 tw per m). The twisted monofilaments were then plied in the Z direction (writhe density=650 tw per m). Coils were made by winding the yarn around different mandrel diameters in single or double self-contacting helixes. The coils had different spring indexes (SI) and bias angles (BA).

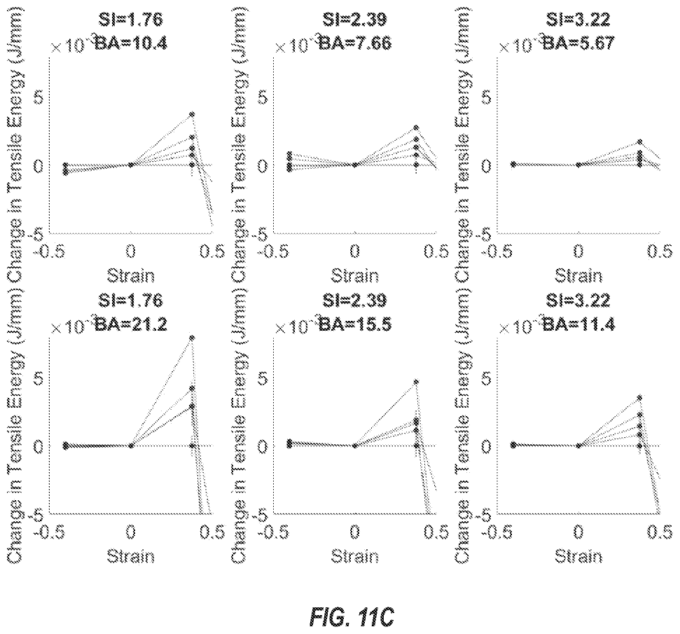

Results are shown in FIGS. 11A-11C. The results demonstrate that helical coil geometry can affect the stress forces generated at specific strain and temperature values even with torsional potential energy of the fiber (the yarn, in this case) kept constant. The separate series in each graph represent different temperatures (200 C, 30° C., 40° C., 50° C., and 60° C.) with higher temperatures typically generating higher forces. Smaller spring index and larger bias angle coils demonstrated higher tensile stresses and energies even though all the coils were made from the same fibers. The results also illustrate that TCPA contraction is governed by more than fiber torque and spring mechanics, possibly due to the unique superhelical structure of the yarn TCPAs as compared to conventional monofilament TCPAs.

### Additional Terms & Definitions

The terms “fiber”, or “polymer fiber”, or “primary fiber”, as used herein, can refer to a monofilament, filament bundle, braided structure, or a yarn. For example, a coil can be formed from a monofilament “fiber” in one embodiment, or a yarn “fiber” in another embodiment. The twist operations described herein can be applied to any of the disclosed types of primary fiber.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

The various features of a given embodiment can be combined with and/or incorporated into other embodiments disclosed herein. Thus, disclosure of certain features relative to a specific embodiment of the present disclosure should not be construed as limiting application or inclusion of said features to the specific embodiment. Rather, it will be appreciated that other embodiments can also include such features.

In addition, unless otherwise indicated, numbers expressing quantities, constituents, distances, or other measurements used in the specification and claims can be optionally modified by addition of the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “monofilament”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted from the disclosed embodiments. For example, polymer materials, additional textile components, and/or TCPA structures that are not specifically disclosed herein may optionally be omitted.

What is claimed is:

1. A twisted, coiled polymer actuator (TCPA) comprising:
a first primary fiber including a twist in a first direction; and
a second primary fiber including a twist in the first direction,
wherein the first and second primary fibers are plied together in a second direction, opposite the first direction, to form a yarn, and
wherein the yarn is coiled, the TCPA thereby comprising three helix levels.

2. The TCPA of claim 1, wherein the yarn is coiled in the first direction.

3. The TCPA of claim 1, wherein the yarn is coiled in the second direction.

4. The TCPA of claim 1, further comprising a conductive element in contact with the first and second primary fibers.

5. The TCPA of claim 4, wherein the conductive element comprises a conductive wire extending within or along the yarn.

6. The TCPA of claim 4, wherein the conductive element comprises a conductive coating.

7. The TCPA of claim 1, wherein the TCPA has a length of 10 cm or greater.

8. The TCPA of claim 1, wherein the yarn is twist-stable.

9. The TCPA of claim 1, wherein the first primary fiber, the second primary fiber, or both comprise a twist level of 400 twists per meter (tw per m) to 25,000 tw per m.

10. The TCPA of claim 1, wherein the yarn comprises an uneven ratio of twist level to writhe level.

11. The TCPA of claim 1, wherein the yarn is a first yarn and is coiled with a second yarn to form a braid.

12. The TCPA of claim 11, wherein:
the second yarn comprises a first primary fiber including a twist in the second direction and a second primary fiber including a twist in the second direction, with the first and second primary fibers plied together in the first direction;
the first yarn is coiled in the second direction; and
the second yarn is coiled in the first direction to braid with the first yarn.

13. A method for manufacturing a twisted, coiled polymer actuator (TCPA), the method comprising:
twisting a first primary fiber in a first direction;
twisting a second primary fiber in a first direction;
plying the first and second primary fibers in a second direction, opposite the first direction, to form a yarn;
coiling the yarn to form a coil; and
annealing the coil.

14. The method of claim 13, wherein coiling the yarn comprises coiling the yarn around a mandrel.

15. The method of claim 13, wherein coiling the yarn comprises coiling the yarn with another yarn to form a braid.

16. The method of claim 13, further comprising adding a lubricant to the first and/or second primary fibers prior to twisting.

17. The method of claim 13, further comprising cyclically stretching the coil.

18. The method of claim 13, further comprising integrating a conductive wire with the first and second primary fibers.

19. The method of claim 13, further comprising pre-coiling of the yarn prior to coiling the yarn and annealing the coil.

20. The method of claim 13, further comprising additional twisting of the yarn after annealing the coil to thereby lower the spring index of the coil.
